(19) United States
(12) Patent Application Publication
(10) Pub. No.: US 2013/0056161 A1
(43) Pub. Date: Mar. 7, 2013

(54) METHOD AND DEVICE FOR WINDING VENETIAN BLINDS OR HONEYCOMB BLINDS

(71) Applicants: Liangxing LIN, Guangzhou City (CN); Junliang DING, Guangzhou City (CN)

(72) Inventors: Liangxing LIN, Guangzhou City (CN); Junliang DING, Guangzhou City (CN)

(73) Assignee: CMECH (GUANGZHOU) INDUSTRIAL LTD.

(21) Appl. No.: 13/280,447

(22) Filed: Oct. 25, 2011

(30) Foreign Application Priority Data
Sep. 2, 2011 (CN) 201110257967.4

(51) Int. Cl. A47H 5/06; E06B 9/326; A47H 5/02

(52) U.S. Cl. 160/84.02; 160/405; 160/84.05

(57) ABSTRACT

A method and device for winding venetian blinds or honeycomb blinds, one ends of said multi-strand lift cords are fixedly connected with the underbeam of the venetian blinds or honeycomb blinds, while the other ends pass through the slats of the venetian blinds or honeycomb blinds converge into a strand rope; and finally the strand rope is fixedly connected with a winding reel which is rotated to wind the rope to realize the action of winding. The winding method of “many cords in one” is used in the present invention. The purpose of controlling the whole set of venetian blinds or honeycomb blinds is achieved by controlling a rope with a winding reel. The venetian blinds or honeycomb blinds of the present invention with simpler structure, more convenient installation, longer operating life, better lifting balance of the blinds, more beautiful products, and less influences of the window size.

### FIELD OF TECHNOLOGY

The invention relates to blinds for door and window, especially to a method and device for winding venetian blinds or honeycomb blinds up and down.

### BACKGROUND

In the prior art, the main components used for winding venetian blinds or honeycomb blinds in motor-driven shading hollow glass up and down are tapes and cords.

The tapes are generally 0.16-0.22 mm thick. Because the tapes are too thin and will rub with the slats when the venetian blinds go up and down which will cause the tapes to fluff, after a great number of up-down winding, the tapes are very likely to wear out and damage the venetian blinds thereby, making the manufacturers and customers have to suffer a loss. Furthermore, the up-down structure of the venetian blinds is realized by the overlap of the tapes. But for hollow products, the hollow interval between two pieces of glass is limited, which makes it unable to provide very high venetian blinds.

Cords are also generally used for controlling the venetian blinds up and down. Generally, at least two cords for the up-down movement is required to enable the slats to remain horizontal when going upwards and downwards. Thus in the existing structure, a winding device is required for each cord. Because each winding device has a certain length, and a driving device for example a electric motor, is also required to be installed in the limited space, which makes it impossible to provide blinds of a small scale thereby. Moreover, because all winding devices work independently, the working situations of all winding devices are difficult to remain synchronized completely, which makes the up-down movement of the venetian blinds controlled by a plurality of cords difficult to achieve a balance thereby.

### SUMMARY

In order to overcome the shortcomings of the prior art, the present invention provides a method and device for winding venetian blinds or honeycomb blinds, which makes the venetian blinds or honeycomb blinds have longer service life, less influence of the size of the window, better balance of up-down movement of the blinds, and more elegant appearance of the product.

Another purpose of the present invention is to provide a winding device to realize the method described above.

In order to realize the technical purposes, the technical solution of the present invention is provided as follow:

A method for winding venetian blinds or honeycomb blinds, wherein one ends of said multi-strand lift cords are fixedly connected with the underbeam of the venetian blinds or honeycomb blinds, while the other ends of the cords pass through the slats of the venetian blinds or honeycomb blinds, converge into a strand rope, and finally, the strand rope is fixedly connected with a winding reel which is rotated to wind the rope to realize the action of winding. A device for winding venetian blinds or honeycomb blinds comprising: multi-strand lift cords, a steering device provided above the slats of the venetian blinds or honeycomb blinds corresponding to each strand lift cord, a winding reel located at the side of the steering device; one end of said each strand lift cord is fixedly connected with the underbeam of the venetian blinds or honeycomb blinds, while the other end of the cord pass through the slats of the venetian blinds or honeycomb blinds and then bypass the steering device respectively, and converge into a strand rope; the end of the strand rope is fixedly connected with said winding reel which is rotated to wind the rope to realize the action of winding.

Said multi-strand lift cords bypass the steering device respectively, and then each end of the cords is gathered and connected with another hauling rope, converging into a strand rope.

One of said multi-strand lift cords extends to form a hauling section, and the ends of other cords are connected with the hauling section of the cord, converging into a strand rope.

A plurality of wheels for steering or guiding the cords are arranged on the trajectory of the motion of the cords between the steering device and the winding reel.

Said winding reel is a screw winding reel or a cylinder winding reel.

Said screw winding reel is sheathed in a threaded winding block which can transfer along the axis of the winding reel; a guide wheel is arranged under the threaded winding block.

Two winding wheels are arranged under the screw winding reel, a steering wheel is arranged at the bottom position inside the side frame of the venetian blinds or honeycomb blinds; said multi-strand lift cords pass through one of said winding wheels, and then extend downward and converge into a strand rope; said rope bypasses the steering wheel, extends upward, passes through the other winding wheel and the guide wheel, and is finally fixed at one end of said screw winding reel.

Said cylinder winding reel have a smooth surface and a certain taper.

At least two winding wheels are arranged under the cylinder winding reel, a steering wheel is arranged at the bottom position inside the side frame of the venetian blinds or honeycomb blinds; multi-strand lift cords pass through one of the winding wheels and then extend downward, and converge into a strand rope; said rope bypasses the steering wheel, extends upward, and passes through another winding wheel, and is finally fixed at one end of said cylinder winding reel.

A motor-driven shading hollow glass device with a device for winding venetian blinds or honeycomb blinds described above.

The winding method of “many cords in one” is used in the present invention. The purpose of controlling the whole set of venetian blinds or honeycomb blinds is achieved by controlling a rope with a winding reel with simpler structure, more convenient installation, longer operating life, better lifting balance of the blinds, more beautiful products, and less influence of the window size. It also breaks through the bottleneck of being unable to produce small products due to the limited inner space of the windows, and is widely applied in motor-driven shading hollow glass.

### BRIEF DESCRIPTION OF THE DRAWINGS

FIG. 1 is the positive structure schematic drawing of the first embodiment of the present invention.

FIG. 2 is the reverse structure schematic drawing of the screw winding reel of the first embodiment of the present invention.

FIG. 3 is the reverse structure schematic drawing of the cylinder winding reel of the second embodiment of the present invention.

### DETAILED DESCRIPTION OF THE INVENTION

A method for winding venetian blinds or honeycomb blinds is provided in the present invention, wherein one ends of the multi-strand cords are fixedly connected with the underbeam of the venetian blinds or honeycomb blinds, while the other ends of the cords pass through the slats of the venetian blinds or honeycomb blinds, converge into a strand rope, and finally, the strand rope is fixedly connected with a winding reel which is rotated to wind the rope to realize the action of winding.

A device for winding venetian blinds or honeycomb blinds comprising: multi-strand cords, a steering device provided above the slats of the venetian blinds or honeycomb blinds corresponding to each strand lift cord, a winding reel located at the side of the steering device; one end of said each strand lift cord is fixedly connected with the underbeam of the venetian blinds or honeycomb blinds, while the other end of the cord passes through the slats of the venetian blinds or honeycomb blinds and then bypasses the steering device respectively, and converges into a strand rope; the end of the strand rope is fixedly connected with said winding reel which is rotated to wind the rope to realize the action of winding.

Said multi-strand lift cords bypass the steering device respectively, and then each end of the cords is gathered and connected with another hauling rope, converging into a strand rope. Alternatively, one of the cords extends to form a hauling section, and the ends of other cords are connected with the hauling section of the cord, converging into a strand rope. No matter which style is used, the purpose is just to realize “many cords in one”. Moreover, a plurality of wheels for steering or guiding the cords are arranged on the trajectory of the motion of the cords between the steering device and the winding reel. The purpose is to make the trajectory of the motion of the cords in the limited space more reasonable and smooth. Said winding reel is a screw winding reel or a cylinder winding reel.

### Embodiment 1

The present invention is further described with the example of venation blinds for window or door in motor-driven shading hollow glass, but the scope of the present invention is not limited to the specific embodiments.

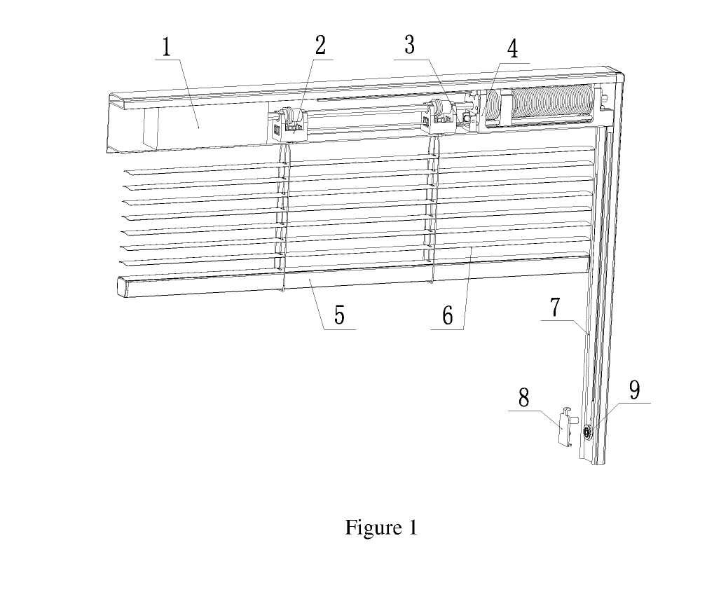

As shown in FIG. 1, the present invention includes a driving source 1, for example a motor, a dimming wheel assembly 2, multi-strand lift cords 3, a winding reel assembly 4, an underbeam 5, a plurality of slats 6 and a hauling rope 7.

The dimming wheel assembly 2 is provided above the slats 6 corresponding to each strand cord. The dimming wheel assembly includes a dimming wheel driving the cords to move and a steering device, for example a steering wheel not shown in the figure, which changes the lift cords 3 from moving vertically to moving horizontally.

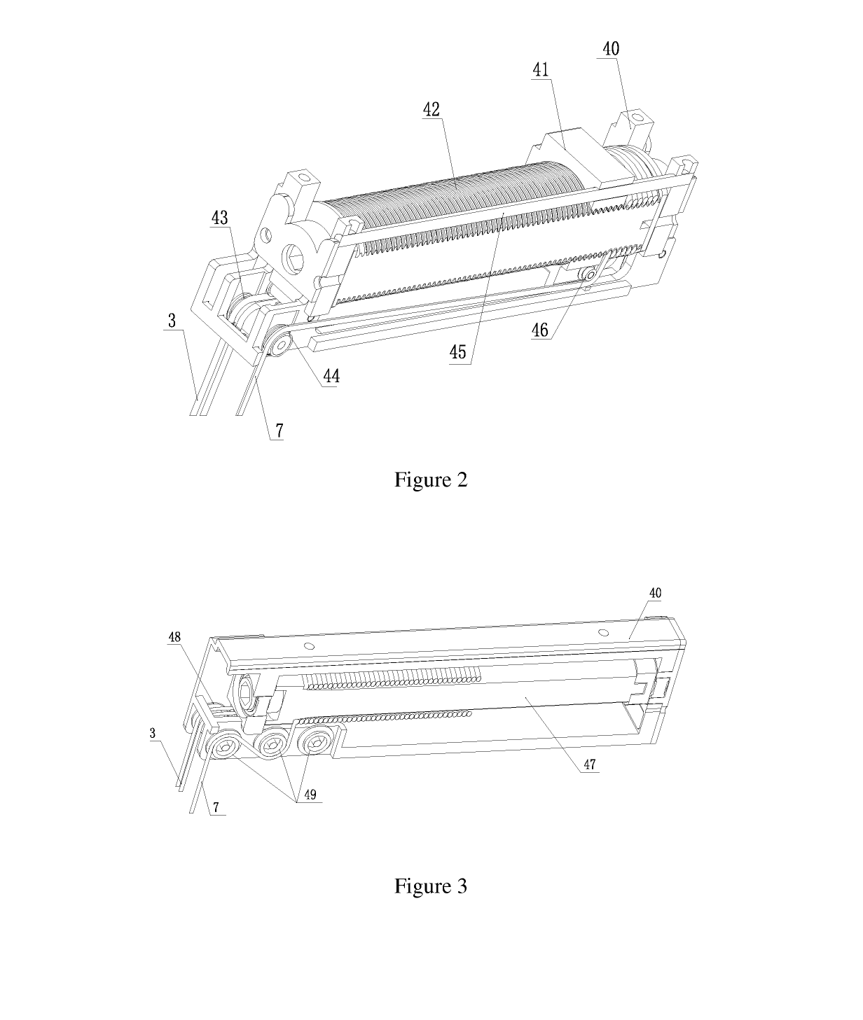

As shown in FIG. 2, the winding reel assembly 4 is located at the side of the dimming wheel assembly 2. The winding reel assembly 4 includes a winding base 40, a threaded winding block 41, a screw winding reel 42, winding wheels 43, 44, a guide shaft 45 and a guide wheel 46. The screw winding reel 42 with a threaded surface is fixed at the winding base 40, and a bearing is arranged at the two ends thereof. The screw winding reel 42 is connected with the driving source 1 through a driving shaft and is driven to rotate. The threaded winding block 41 is sheathed on the screw winding reel 42, and the inner thread of the threaded winding block 41 is engaged with the outer thread of the screw winding reel 42. Two guide shafts 45 are provided on the winding base 40 and used in accordance with the groove on the outer wall of the threaded winding block 41, which makes the threaded winding block 41 cannot rotate with the rotation of the screw winding reel 42 but just transfer along the axis of the screw winding reel 42.

A plurality of wheels for steering or guiding the cords are arranged at the trajectory of motion of the cords between the steering device and the winding reel. For example, the guide wheel 46 is arranged under the threaded winding block 41 and move together with the threaded winding block 41; two winding wheels 43 and 44 are arranged under the screw winding reel 42; a steering wheel 9 is fixed at the bottom position inside the side frame of the slats 6 by a steering base 8.

During installation, one end of each strand lift cord 3 is fixedly connected with the underbeam 5 of the slats 6, and the other end passes through the slats 6 from bottom to top, bypasses the steering device respectively, turns to the direction of the winding reel assembly 4, then passes through one of the winding wheels 43, extends downward and is bound by the hauling rope 7, and therefore converges into a strand rope. The rope bypasses the steering wheel 9, then extends upward, passes through the other winding wheel 44 and the guide wheel 46, and is finally fixed at one end of the screw winding reel 42. Principle of operation: the screw winding reel 42 is driven by the driving source 1 to move in circles, while the threaded winding block 41 only can move back and forth horizontally because of the restriction of the two guide shafts. Meanwhile, the hauling rope 7, which goes through the guide wheel 46 and then passes through the threaded winding block 41, is bound around the thread on the surface of the screw winding reel 42 with the movement of the threaded winding block 41 in turns without tying knots. The winding number of the hauling rope 7 is increased or decreased by rotating the screw winding reel 42 forward or backward, causing the slats 6 is pulled to move upward or downward by the multi-strand lift cords 3 synchronously.

### Embodiment 2

This embodiment, like the first embodiment, includes a driving source 1, for example a motor, a dimming wheel assembly 2, multi-strand lift cords 3, a winding reel assembly 4, an underbeam 5, a plurality of slats louver blades 6, a hauling rope 7, a steering wheel and the like. As shown in FIG. 3, the winding reel assembly 4 is located at the side of the dimming wheel assembly 2, and includes a winding base 40, a screw winding reel 42 driven to move in circles by the driving source 1, and at least two winding wheels. The surface of the cylinder winding reel 47 is smooth and with a certain taper is fixed on the winding base 40 with bearings at its two ends. In this embodiment, four winding wheels are arranged under the cylinder winding reel 47. The multi-strand lift cords 3 pass through one of the winding wheels and then extend downward, and are bound by another strand hauling rope 7. The hauling rope 7 bypasses the steering wheel 9, extends upward, passes through another three winding wheels 49, and is finally fixed at the end of the cylinder winding reel 47 with a larger diameter.

The operation principle is as follow: the operation principle of the cylinder winding reel is similar to the operation principle of the screw winding reel. The cylinder winding reel 47 is driven to move in circles by the driving source 1. Since the surface of the cylinder winding reel 47 has a certain taper, the cords can in turns wind around the cylinder winding reel from the end with larger diameter to the end with smaller diameter without tying knots. With the forward or backward rotation of the cylinder winding reel 47, the winding number of the hauling rope 7 is increased or decreased, causing the slats 6 is pulled to move upward or downward by them multi-strand lift cords 3 synchronously.

The embodiments described above are only the preferred embodiments of the present invention and do not intend to limit the present invention in any form. Any simple modifications, equivalent replacements and improvements of the embodiments mentioned above according to the technical essence of the present invention should fall within the scope of the technical solution of the present invention.

What is claimed is:

1. A method for winding venetian blinds or honeycomb blinds, wherein one ends of the multi-strand lift cords are fixedly connected with the underbeam of the venetian blinds or honeycomb blinds, while the other ends of the multi-strand lift cords pass through the slats of the venetian blinds or honeycomb blinds, and converge into a strand rope, and finally the strand rope is fixedly connected with a winding reel which is rotated to wind the rope to realize the action of winding.

2. A device for winding venetian blinds or honeycomb blinds, wherein comprising: multi-strand lift cords, a steering device provided above the slats of the venetian blinds or honeycomb blinds corresponding to each strand lift cord, a winding reel located at the side of the steering device; one end of said each strand lift cord is fixedly connected with the underbeam of the venetian blinds or honeycomb blinds, while the other end of the cord passes through the slats of the venetian blinds or honeycomb blinds and then bypasses the steering device respectively, and converges into a strand rope; the end of the strand rope is fixedly connected with said winding reel which is rotated to wind the rope to realize the action of winding.

3. A device for winding venetian blinds or honeycomb blinds according to claim 2, wherein said the multi-strand lift cords bypass the steering device respectively, and then each end of the cords is gathered and connected with another hauling rope, converging into a strand rope; or one of said multi-strand lift cords extends to form a hauling section, and the ends of other lift cords are connected with the hauling section of the strand lift cord, converging into a strand rope.

4. A device for winding venetian blinds or honeycomb blinds according to claim 2, wherein a plurality of wheels for steering or guiding the cords are arranged on the trajectory of the motion of the cords between the steering device and the winding reel.

5. A device for winding venetian blinds or honeycomb blinds according to claim 2, wherein said winding reel is a screw winding reel or a cylinder winding reel.

6. A device for winding venetian blinds or honeycomb blinds according to claim 5, wherein said screw winding reel is sheathed in a threaded winding block which can transfer along the axis of the winding reel; a guide wheel is arranged under the threaded winding block.

7. A device winding for venetian blinds or honeycomb blinds according to claim 5, wherein two winding wheels are arranged under the screw winding reel, a steering wheel is arranged at the bottom position inside the side frame of the venetian blinds or honeycomb blinds; said multi-strand lift cords pass through one of said winding wheels and then extend downward and converge into a strand rope; the strand rope bypasses the steering wheel, extends upward, passes through the other winding wheel and the guide wheel, and is finally fixed at one end of said screw winding reel.

8. A device for winding venetian blinds or honeycomb blinds according to claim 5, wherein said cylinder winding reel have a smooth surface and a certain taper.

9. A device for winding venetian blinds or honeycomb blinds according to claim 5, wherein at least two winding wheels are arranged under the cylinder winding reel, a steering wheel is arranged at the bottom position inside the side frame of the venetian blinds or honeycomb blinds; said multi-strand cords pass through one of the winding wheels, extend downward, and converge into a strand rope; said strand rope bypasses the steering wheel, extends upward, passes through another winding wheels, and is finally fixed at one end of said cylinder winding reel.

10. A motor-driven shading hollow glass device with a device for winding venetian blinds or honeycomb blinds of claim 2.

11. A motor-driven shading hollow glass device with a device for winding venetian blinds or honeycomb blinds of claim 3.

12. A motor-driven shading hollow glass device with a device for winding venetian blinds or honeycomb blinds of claim 4.

13. A motor-driven shading hollow glass device with a device for winding venetian blinds or honeycomb blinds of claim 5.

14. A motor-driven shading hollow glass device with a device for winding venetian blinds or honeycomb blinds of claim 6.

15. A motor-driven shading hollow glass device with a device for winding venetian blinds or honeycomb blinds of claim 7.

16. A motor-driven shading hollow glass device with a device for winding venetian blinds or honeycomb blinds of claim 8.

17. A motor-driven shading hollow glass device with a device for winding venetian blinds or honeycomb blinds of claim 9.
